(19) United States
(12) Patent Application Publication
(10) Pub. No.: US 2024/0265236 A1
(43) Pub. Date: Aug. 8, 2024

(54) ASSOCIATIVE MEMORY DEVICE

(71) Applicant: Mitsubishi Electric Corporation, Tokyo (JP)

(72) Inventor: Hiroshi KAGE, Tokyo (JP)

(73) Assignee: Mitsubishi Electric Corporation, Tokyo (JP)

(21) Appl. No.: 18/565,084

(22) PCT Filed: Jun. 23, 2021
(86) PCT No.: PCT/JP2021/023693

§ 371 Date: Nov. 29, 2023

(51) Int. Cl. G06N 3/044

(52) U.S. Cl. CPC G06N 3/044

(57) ABSTRACT

An associative memory device includes a memory pattern specifying unit that stores a fixed-length numeric vector as a memory pattern; a recall pattern specifying unit that stores a numeric vector associated with the memory pattern as a recall pattern; an associative memory learning unit that acquires an associative memory circuit through learning by using an echo state network including an input layer, an intermediate layer, and an output layer. The values of all units constituting the input layer are input in parallel to the intermediate layer. The values are output in parallel from the intermediate layer through neural network processing performed within the intermediate layer set as values of all units constituting the output layer. The recall pattern is output in parallel from the associative memory circuit.

### TECHNICAL FIELD

The present disclosure relates to an associative memory device that outputs appropriate responses in the form of text or sound as sentences in a natural language by having the function of automatically correcting user-entered sentences that may contain errors or of inferring associated sentences from ambiguous sentences in a natural language-based dialogue system.

### BACKGROUND ART

In conventional digital computers, specific memory information is accessed through address designation. However, a distinct technology field called associative memory has been established as a different means for accessing memory information. In the associative memory, by inputting only a part of a desired pattern (such as an image, a sound, or a symbol), the entire pattern is outputted to retrieve the memory information. This associative memory technology can be applied not only to two-dimensional pattern learning, but also to natural language processing, which is composed of time series signals. In the natural language processing, the associative memory is required to analyze the meaning of each word, but in addition, the time-series signal processing is also necessary when word sequences are regarded as the time-series signals.

For example, Non-Patent Document 1 describes a method for constituting associative memory by using a method called Restricted Boltzmann Machine (RBM), which is a recurrent neural circuit model known in the field of neural networks. In general, there are two types of associative memory. The first associative memory is a mutual recall type associative memory in which pattern B that is different from pattern A is recalled from pattern A. The second associative memory is a self-recall type associative memory in which pattern A recalls itself. Regarding how to use the associative memory, the mutual recall type associative memory is used, for example, to recall from one word, another word that has a similar meaning. For example, when a word contains spelling errors or other defective parts, or when an image contains defective parts, the self-recall type associative memory is used to recall an original word or image with the defective parts corrected.

In general, associative memory can also be implemented by auto-encoders of non-recurrent neural circuit models, which are often used in the field of deep learning. However, a non-recurrent neural circuit model is a deterministic associative memory in which the output pattern is uniquely determined from the input pattern. On the other hand, the recurrent neural circuit model has a loop structure inside the circuit and thus operates differently from the non-recurrent neural circuit model. The use of the recurrent neural circuit model can take advantage of fluctuations in the output from the associative memory due to the mechanical dynamics caused by the loop structure inside the circuit. Therefore, the recurrent neural circuit model is more useful than the non-recurrent neural circuit model in that it can create various pattern recalls.

### PRIOR ART REFERENCE

### Non-Patent Reference

Non-Patent Reference 1: “Analog Value Associative Memory Using Restricted Boltzmann Machine”, Journal of Advanced Computational Intelligence and Intelligent Informatics, Vol. 23(1), pp. 60-66, 2019.

### SUMMARY OF THE INVENTION

### Problem to be Solved by the Invention

In conventional associative memory devices, in consideration of their application to the natural language processing, RBM is designed for recognizing static patterns. To recognize time-series signals, the use of a Dynamic Boltzmann Machine (DyBM), which is an improved version of RBM, is separately required in addition to the associative memory. In other words, an additional circuit that implements DyBM as the improved version of RBM needs to be provided in the conventional associative memory device separately from RBM for information processing such as natural language processing; the information processing requires both time-series signal recognition necessary for syntactic analysis of sentences in which words are arranged in time series and static pattern recognition necessary for semantic analysis of words. As a result, this causes a problem of an increase in hardware resources during system implementation. Furthermore, when the recurrent neural circuit model is used to implement the associative memory that learns general patterns such as two-dimensional images, not limited to natural language processing, there is an issue associated with the combinatorial explosion of computational complexity in converging the learning of RBM.

The present disclosure has been made to solve the above problem and is intended to provide an associative memory device which can avoid the problem of the combinatorial explosion of computational complexity in converging the learning when an associative memory circuit is constructed and which can implement an information processing system capable of operating at high speed.

### Means of Solving the Problem

An associative memory device according to the present disclosure includes: a memory pattern specifying unit that stores a fixed-length numeric vector as a memory pattern; a recall pattern specifying unit that stores a numeric vector associated with the memory pattern as a recall pattern; an associative memory learning unit that acquires an associative memory circuit through learning by using an echo state network including an input layer, an intermediate layer, and an output layer, values of all units constituting the input layer being input in parallel to the intermediate layer, values output in parallel from the intermediate layer through neural network processing performed within the intermediate layer being set as values of all units constituting the output layer, the recall pattern being output in parallel from the associative memory circuit by inputting the memory pattern in parallel to the associative memory circuit; and an associative memory processing unit that holds therein the associative memory circuit acquired by the associative memory learning unit through learning.

### Effects of the Invention

According to the present disclosure, the associative memory circuit can be acquired through learning with the echo state network, which is a recurrent neural circuit model, thus making it possible to avoid the problem of the combinatorial explosion of computational complexity in converging the learning and also to implement the information processing system capable of operating at high speed.

### BRIEF DESCRIPTION OF THE DRAWINGS

FIG. 1 is a block diagram showing a configuration of respective operating units of an associative memory device according to a first embodiment.

FIGS. 2A and 2B show a learning operation of an associative memory learning unit and a utilization mode of an associative memory processing unit according to the first embodiment.

FIGS. 3A to 3C show a learning operation of the associative memory learning unit and a utilization mode of the associative memory processing unit according to the first embodiment.

FIGS. 4A and 4B show flowcharts showing the operations of the associative memory device according to the first embodiment.

FIG. 5 is a block diagram showing a configuration of respective operating units of an associative memory device according to a second embodiment.

FIGS. 6A to 6J show an example of processing performed by each operating unit of the associative memory device according to the second embodiment.

FIG. 7 is a block diagram showing a configuration of respective operating units of an associative memory device according to a third embodiment.

FIG. 8 shows a learning operation of an associative memory learning unit and a utilization mode of an associative memory processing unit according to the third embodiment.

FIGS. 9A and 9B show a hardware configuration of the associative memory devices according to the first to third embodiments.

### MODE FOR CARRYING OUT THE INVENTION

### First Embodiment

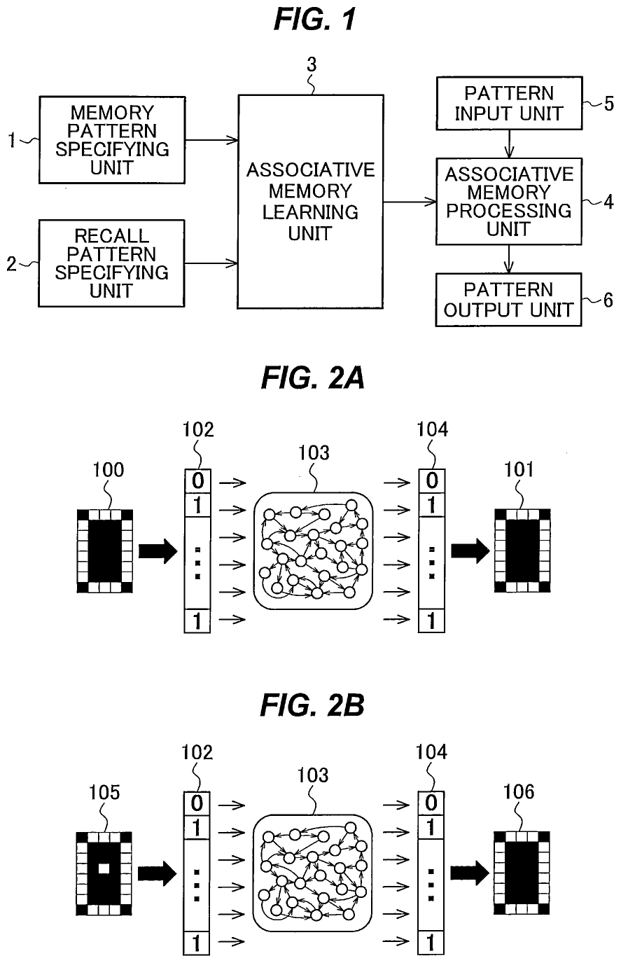

FIG. 1 is a block diagram showing a configuration of respective operating units of an associative memory device according to a first embodiment. The associative memory device performs associative memory learning to process pattern information. As shown in FIG. 1, the associative memory device includes a memory pattern specifying unit 1, a recall pattern specifying unit 2, an associative memory learning unit 3, an associative memory processing unit 4, a pattern input unit 5, and a pattern output unit 6.

The memory pattern specifying unit 1 treats a two-dimensional image or one-dimensional signal as a fixed-length numeric vector and stores the numeric vector as a memory pattern. The recall pattern specifying unit 2 stores, as a recall pattern, the numeric vector associated with the memory pattern stored in the memory pattern specifying unit 1.

The associative memory learning unit 3 receives a memory pattern input from the memory pattern specifying unit 1 and receives a recall pattern input from the recall pattern specifying unit 2. The associative memory learning unit 3 learns the memory pattern and recall pattern as a learning set by utilizing the Echo State Network, which is a recurrent neural circuit model, such that the recall pattern is output once the memory pattern is input. The Echo State Network is composed of three layers, namely, an input layer, an intermediate layer, and an output layer. An associative memory circuit using the trained echo state network is acquired, in which values of all units constituting the input layer are input in parallel to the intermediate layer, neural network processing is performed on the intermediate layer, and values output in parallel from the intermediate layer are set as values of all units constituting the output layer. The associative memory circuit has the function of automatically correcting sentences that may contain errors or of inferring associative sentences from ambiguous sentences, and it outputs appropriate responses in the form of text or sound as sentences in the natural language. The associative memory learning unit 3 uses this associative memory circuit so that when a memory pattern is input in parallel to the associative memory circuit, a recall pattern is output in parallel from the associative memory circuit. The associative memory processing unit 4 holds therein the associative memory circuit acquired by the associative memory learning unit 3 through the learning and uses the associative memory circuit to automatically correct letters, symbols, or sentences.

The pattern input unit 5 stores letters, symbols, or sentences that may contain errors, or ambiguous sentences, as input patterns. The associative memory processing unit 4 uses the associative memory circuit held therein to infer appropriate sentences as sentences in the natural language for the input patterns input from the pattern input unit 5, and automatically corrects them. The associative memory processing unit 4 outputs the automatically corrected input pattern as an output pattern. The pattern output unit 6 stores letters, symbols, or sentences, which are automatically corrected by the associative memory processing unit 4, as output patterns. The input and output patterns may be sound.

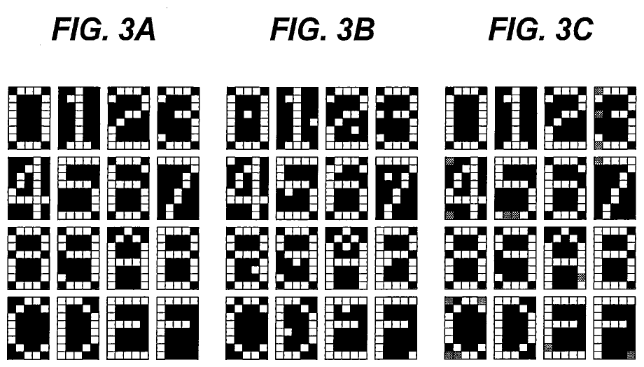

FIGS. 2A and 2B and 3A to 3C each show the learning operation of the associative memory learning unit 3 and the utilization mode of the associative memory processing unit 4, which are examples of self-recall type associative memory learning of two-dimensional patterns with the associative memory circuit. First, a description will be given on the self-recall type associative memory that is performed by an associative memory circuit which uses the echo state network for 16 hexadecimal digit patterns, each composed of two-dimensional patterns of 5×8 pixels. The self-recall type associative memory is, for example, associative memory in which pattern A recalls itself. Referring to FIGS. 2A and 2B, a description will be given on an operation of the self-recall type associative memory, in which the associative memory circuit receives each input pattern partially containing a pixel defect, automatically corrects the pixel defect, and outputs each automatically corrected pattern.

FIGS. 2A and 2B each show the relationship between a memory pattern and a recall pattern. The memory pattern and recall pattern constitute the learning set that should be prepared to execute self-recall type associative memory learning utilizing the echo state network. In FIG. 2A, the echo state network is composed of three layers, namely, an input layer 102, an intermediate layer 103, and an output layer 104. Reference numeral 100 is an example of a memory pattern corresponding to “0” in hexadecimal notation which is input to the echo state network. Reference numeral 101 is an example of a recall pattern corresponding to “0” in the hexadecimal notation which is output from the echo state network.

In FIG. 2B, reference numeral 105 is an example of a memory pattern including a defect. Reference numeral 106 is an example of a recall pattern output from the echo state network. As shown in FIG. 2B, when the memory pattern 105 contains a defective part, the memory pattern 105 is input to the input layer 102, while the recall pattern 106 is output from the output layer 104, but the defect contained in the memory pattern 105 is automatically corrected. That is, when the memory pattern containing the defect is input to the echo state network with the self-recall type associative memory trained, the recall pattern output from the echo state network has the defective part automatically corrected.

As shown in FIGS. 2A and 2B, the memory pattern input to the input layer 102 is input in parallel to the intermediate layer 103 as a vector. The recall pattern output to the output layer 104 is then output in parallel from the intermediate layer 103 as another vector.

The self-recall type associative memory learning utilizing the echo state network will be described. The input layer 102 reads out the individual pixel values of the memory pattern 100, composed of 5 horizontal by 8 vertical pixels, and sets the read pixel value in each unit of the input layer 102. The order in which the individual pixel values of the memory pattern 100 are read out can be arbitrary as long as it is fixed, but the input layer 102 usually reads the pixel values of each row from left to right, while moving the reading row position from top to bottom, thereby reading out the whole pixel values from the top left corner to the right corner, as is customary, and sets the pixel values as the vector in this order from top to bottom for respective units of the input layer 102. The output layer 104 sets the pixel values of the recall pattern 101 in the respective units of the output layer 104 in a reading order that is the same as this reading order in the input layer 102.

FIG. 3A shows 16 hexadecimal digit patterns used as the learning set. In the self-recall type associative memory learning that uses the echo state network, the memory pattern and the recall pattern which constitute the learning set need to be identical to each other. Not only the associative memory learning, but also learning using a general echo state network can be executed in accordance with an algorithm shown in Reference 1. As a result, the self-recall associative memory learning has been completed for a plurality of different patterns as shown in FIG. 3A.
(Reference 1) Lukosevicius, “A Practical Guide to Applying Echo State Networks”, Lecture Notes in Computer Science, vol. 7700, pp. 659-686, 2012.

FIG. 3B shows patterns where a defective part is contained in each of the 16 hexadecimal digits used as the learning set by way of example. FIG. 3C shows each recall pattern output from the output layer 104 when each of the memory patterns shown in FIG. 3B is input to the echo state network with the self-recall type associative memory trained, and the defective parts of all patterns are automatically corrected. In other words, by inputting the memory pattern containing the defective part into the echo state network, the defective part can be automatically corrected.

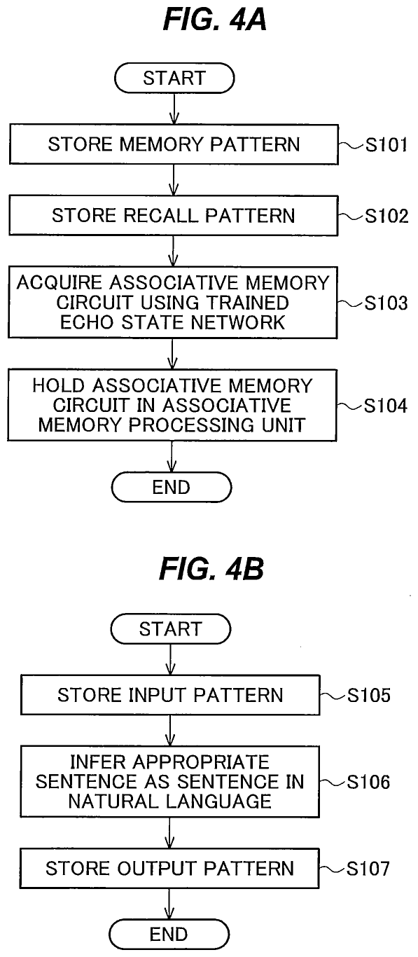

The operation of the associative memory device will now be described. FIGS. 4A and 4B show flowcharts showing operations of the associative memory device. First, the acquisition flow of the associative memory circuit is described using FIG. 4A. In step S101, the memory pattern specifying unit 1 treats a two-dimensional image or one-dimensional signal as a fixed-length numeric vector and stores the numeric vector as a memory pattern. In step S102, the recall pattern specifying unit 2 stores, as the recall pattern, a numeric vector associated with the memory pattern stored in the memory pattern specifying unit 1. In step S103, the associative memory learning unit 3 learns the memory pattern and the recall pattern as the learning set by using the echo state network such that the recall pattern is output once the memory pattern is input. As a result, the associative memory learning unit 3 acquires an associative memory circuit that uses the trained echo state network. In step S104, the associative memory processing unit 4 holds therein the associative memory circuit acquired by the associative memory learning unit 3 through the learning.

Next, the flow of the operation performed by the associative memory circuit will be described with reference to FIG. 4B. In step S105, the pattern input unit 5 stores a letter, symbol, or sentence which may contain an errors or ambiguous sentence, as an input pattern. In step S106, the associative memory processing unit 4 uses the associative memory circuit held therein to infer an appropriate sentence as a sentence in the natural language for the input pattern input from the pattern input unit 5 and automatically corrects it. In step S107, the pattern output unit 6 stores the letter, symbol, or sentence automatically corrected by the associative memory processing unit 4 as an output pattern.

It is noted that in the present embodiment, an example has been described in which the self-recall type associative memory learning is performed using the echo state network, thereby producing the recall pattern from the memory pattern containing a defective part in such a manner as to compensate for the defective part. However, by using the echo state network to perform mutual recall type associative memory learning, which is another type of associative memory described in the background art, it is also possible to recall another pattern from one pattern, for example, from a hexadecimal digit “0” to a hexadecimal digit “1”.

In the present embodiment, an example has been described in which the self-recall type associative memory learning using the echo state network is to learn the image patterns as shown in FIGS. 3A to 3C. However, the associative memory learning can be performed for words expressed in symbols, such as natural language. For example, by using a technique known in the field of natural language processing, called word2vec, it is possible to represent a plurality of words used in a specific context as vectors whose elements have quantitative values. Therefore, by using word2vec to convert the symbolic representation of a word into a vector representation, the same learning as the associative memory learning for the images as shown in FIGS. 3A to 3C can be achieved, and both the self-recall and mutual recall type associative memory learning can also be achieved.

In the present embodiment, the usage of the word2vec has been explained by way of example as means for vectoring words, which are exemplified as an example of application to objects other than images, but other vectorization means suitable for use include, for example, a method of executing numeric vectorization by using an ASCII code or the like as each letter composing a word (e.g., apple is expressed as (0x61, 0x70, 0x70, 0x6c, 0x65), where 0x is a hexadecimal representation), a similar vectorization method, and a method which involves assigning back numbers to 256 fixed words and converting each back number into an 8-bit binary digit to execute numeric vectorization (e.g., converting the back number 129 to binary digits (1,0,0,0,0,0,0,1)).

Thus, the self-recall type associative memory learning using the echo state network can automatically correct an image pattern that partially contains a defective part in the field of image recognition. In addition, the self-recall type associative memory learning using the echo state network can automatically correct a misspelled word that occurs when a text is inputted, or a defect or error in a word that occurs when a document is inputted via Optical Character Recognition (OCR), thereby producing a correct word in the field of the natural language processing. Further, the mutual recall type associative memory learning using the echo state network can associate a word included in an inference rule owned by an inference engine with another word in an inference process performed on the inference engine that uses the natural language as input, and thus enables a new knowledge to expand.

As described above, the associative memory circuit can be acquired through the learning with the echo state network, which is the recurrent neural circuit model, thus avoiding the problem of the combinatorial explosion of computational complexity in converging the learning and also to implement the information processing system capable of operating at high speed.

### Second Embodiment

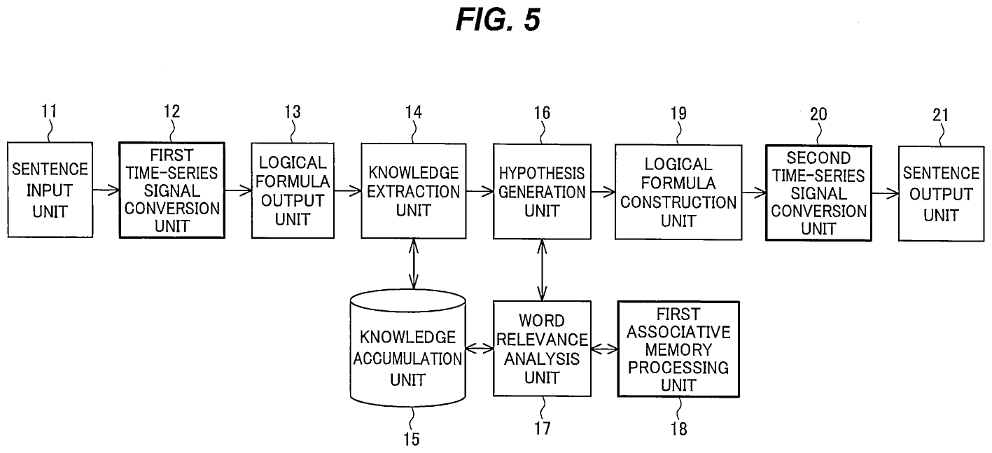

FIG. 5 is a block diagram showing a configuration of respective operating units of an associative memory device according to a second embodiment. The associative memory device performs information processing which includes time-series signal learning for processing time-series information and associative memory learning for processing pattern information. In FIG. 5, the associative memory device includes a sentence input unit 11, a first time-series signal conversion unit 12, a logical formula output unit 13, a knowledge extraction unit 14, a knowledge accumulation unit 15, a hypothesis generation unit 16, a word relevance analysis unit 17, a first associative memory processing unit 18, a logical formula construction unit 19, a second time-series signal conversion unit 20, and a sentence output unit 21.

In the natural language processing, in addition to the need for the mutual recall type associative memory for semantic analysis of each word, it is also necessary to perform time-series signal processing when word sequences are viewed as time-series signals. In the present embodiment, the natural language is converted to predicate logic by using time-series signal conversion in the echo state network. Furthermore, hypothetical reasoning is introduced into an inference process of the predicate logic, and knowledge not found in a knowledge database is newly generated by using the mutual recall type associative memory of words expressed as vectors with word2vec in the inference process, thus leading to the expansion of knowledge, which will be described herein.

The sentence input unit 11 stores input sentences expressed in the natural language. The first time-series signal conversion unit 12 holds therein a first time-series signal conversion circuit acquired through the time-series signal learning with the echo state network. The first time-series signal conversion circuit is acquired through the learning with the echo state network such that the associative memory circuit is acquired through the learning with the echo state network in the associative memory learning unit 3 described in the first embodiment.

The first time-series signal conversion unit 12 converts an input sentence into a predicate logical formula by using the first time-series signal conversion circuit. The logical formula output unit 13 stores the predicate logical formula output by the first time-series signal conversion unit 12.

The knowledge accumulation unit 15 accumulates knowledge in the inference engine where all knowledge is stored as a knowledge database in the form of predicate logic and inference is performed in accordance with the rules of the predicate logic. The knowledge accumulation unit 15 then searches for a knowledge accumulated in the inference engine by using a predicate logical formula stored in the logical formula output unit 13. The knowledge extraction unit 14 conducts a search across the knowledge accumulation unit 15 by using the predicate logical formula stored in the logical formula output unit 13 as a search logical formula, and acquires the predicate logical formula, which is a search result, as a candidate conditional logical formula.

The hypothesis generation unit 16 verifies the search logical formula, which is the predicate logical formulas stored in the logical formula output unit 13 and used by the knowledge extraction unit 14, against the candidate conditional logical formula acquired by the knowledge extraction unit 14 by using hypothetical reasoning. Based on this hypothetical reasoning, it generates a plurality of hypothetical logical formulas.

The word relevance analysis unit 17 checks on a symbolic basis whether each of the words constituting the plurality of hypothetical logical formulas generated by the hypothesis generation unit 16 is included in the knowledge database owned by the knowledge accumulation unit 15. Then, the word relevance analysis unit 17 selects an operation of either the self-recall type associative memory or mutual recall type associative memory. In addition, the word relevance analysis unit 17 extracts a hypothetical logical formula that is determined to be included in the knowledge database on the symbolic basis from among the plurality of hypothetical logical formulas. The word relevance analysis unit 17 sends, to the first associative memory processing unit 18, the operation selection information regarding whether to select the operation of the self-recall or mutual recall type associative memory, as well as the hypothetical logical formula determining that the word is included in the knowledge database on the symbolic base.

The first associative memory processing unit 18 holds therein the first associative memory circuit acquired through the associative memory learning with the echo state network. The first associative memory circuit is acquired through learning with the echo state network in the same way as in the first embodiment where the associative memory circuit is acquired through the learning with the echo state network in the associative memory learning unit 3. The first associative memory processing unit 18 executes the first associative memory circuit for the hypothetical logical formula sent from the word relevance analysis unit 17, based on the operation selection information about either the self-recall or mutual recall type associative memory, which information has been determined by the word relevance analysis unit 17, and it then sends the associative hypothesis logical formula resulting from the execution to the word relevance analysis unit 17.

The logical formula construction unit 19 stores an output logical formula that is selected from the associative hypothesis logical formulas by the word relevance analysis unit 17. The second time-series signal conversion unit 20 holds therein a second time-series signal conversion circuit acquired through the time-series signal learning with the echo state network. The second time-series signal conversion circuit is acquired through the learning with the echo state network in the same way as in the first embodiment where the associative memory circuit is acquired through the learning with the echo state network in the associative memory learning unit 3. The first time-series signal conversion circuit held inside the first time-series signal conversion unit 12 is trained to execute conversion from a sentence in the natural language to a logical formula. In contrast, the second time-series signal conversion circuit held inside the second time-series signal conversion unit 20 is different in that it is trained to execute conversion from a logical formula to a sentence in the natural language. The second time-series signal conversion unit 20 uses the second time-series signal conversion circuit to convert the output logical formula stored in the logical formula construction unit 19 into an output sentence expressed in the natural language. The sentence output unit 21 externally outputs the output sentence converted by the second time-series signal conversion unit 20.

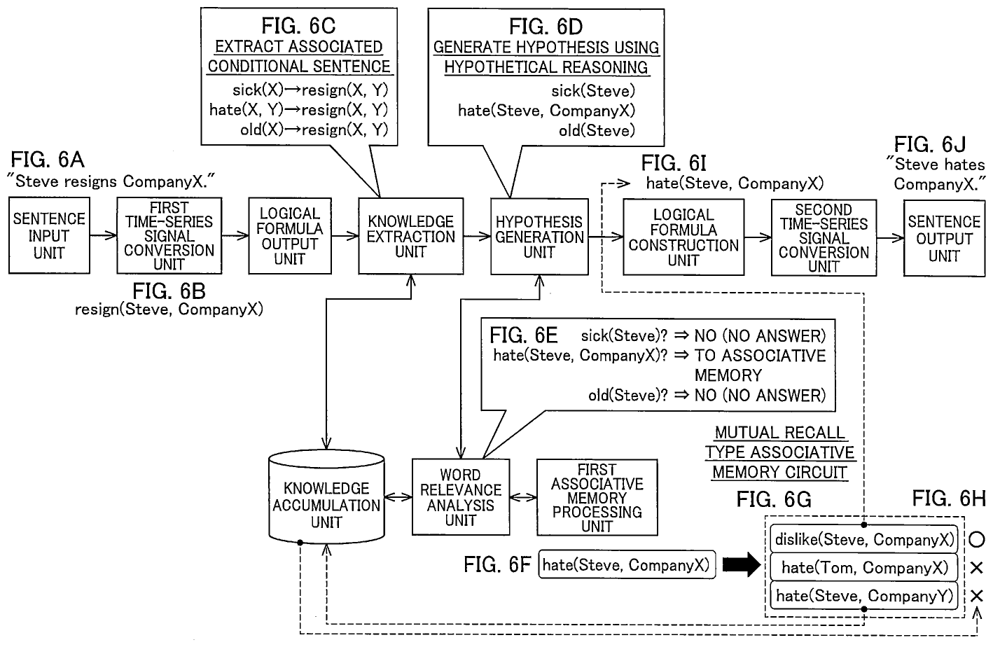

FIGS. 6A to 6H show an example of processing performed by respective operating units of the associative memory device according to the second embodiment. In FIGS. 6A to 6H, an example is shown in which a sentence in the natural language is converted into a predicate logical formula, and the associative memory is applied to this predicate logical formula to derive a new logical formula, which is then converted back to a sentence in the natural language again and output externally. With reference to FIGS. 6A to 6H, a description will be given on an operation in which a sentence in the natural language where each word is represented as a vector is converted into a predicate logical formula represented as a vector in the same way, by means of the first time-series signal processing circuit constructed by the time-series signal learning with the echo state network in the case of inputting sentences in the natural language. Hereinafter, the respective operations of the sentence input unit 11 to the sentence output unit 21 correspond to the operations indicated by steps A to J in FIGS. 6A to 6H.

In the present embodiment, the word relevance analysis unit 17 has a self-recall type associative memory circuit that converts the logical formulas into a 0/1 vector to train the self-recall type memory circuit. Then, the word relevance analysis unit 17 converts a large number of logical formulas into 0/1 vectors in advance by using word2vec and trains the self-recall type memory circuit. Here, the word2vec is a technology widely used in Google (registered trademark) search or the like. Its conversion rules are devised such that words with similar meanings have similar 0/1 vectors.

First, in step A, a sentence (1) input by a user and stored in the sentence input unit 11, e.g.,

“Steve resigns CompanyX.” (1),
is sent to the first time-series signal conversion unit 12.

In step B, the first time-series signal conversion unit 12 converts the sentence (1) into a predicate logical formula (2),

“resign(Steve,CompanyX)” (2),
and outputs it to the logical formula output unit 13. The conversion from the sentence (1) to the predicate logical formula (2) can be implemented by the first time-series signal conversion circuit acquired through learning with the echo state network as shown in Reference 2.
(Reference 2) Hinaut, X. et al., “Cortico-Striatal Response Selection in Sentence Production: Insights from neural network simulation with Reservoir Computing.”, Brain and Language, vol. 150, November 2015, pp. 54-68.

In step C, the predicate logical formula (2) stored in the logical formula output unit 13 is input to the knowledge extraction unit 14. The knowledge extraction unit 14 extracts, for example, the following three logical formulas as conditional logical formulas having the logical formula (2) as a consequence part, from conditional logical formulas accumulated in the inference engine that has been accumulated in the knowledge accumulation unit 15 (in the form of A-B when A is a postulate and B is a consequence).

“sick(X,Y)→resign(X,Y)” (3)

“hate(X,Y)→resign(X,Y)” (4)

“old(X,Y)→resign(X,Y)” (5)

It is noted that as the inference engine accumulated in the knowledge accumulation unit 15, there is an example of construction using the logic-based language Prolog, described in Reference 3.
(Reference 3) U.S. Pat. No. 8,180,758, “Data management system utilizing predicate logic”, Amazon Technologies, Inc.

In step D, the hypothesis generation unit 16 verifies the logical formula (2) against the consequence parts of the logical formulas (3) to (5) to acquire variables “X=Steve” and “Y=CompanyX”. These variables are substituted into hypothetical portions of the logical formulas (3) to (5), whereby

“sick(Steve).” (6)

“hate(Steve,CompanyX).” (7)

“old(Steve).” (8)

are constructed as the hypothetical logical formulas and output to the word relevance analysis unit 17.

In step E, the word relevance analysis unit 17 checks whether or not a knowledge similar to each of the logical formulas (6) to (8) is contained in the knowledge database inside the knowledge accumulation unit 15 by using only the form of the logical formula as the symbol in order to check the validity of the logical formulas (6) to (8). If it turns out that the logical formulas (6) and (8) are in the form of ‘logical formulas having “Steve” as one parameter’, but these logical formulas in this form are not contained in the knowledge database inside the knowledge accumulation unit 15, and that the form of the logical formula (7), i.e., the ‘logical formula with two parameters including “Steve” or “CompanyX”’, is contained in the knowledge database within the knowledge accumulation unit 15, then the word relevance analysis unit 17 outputs the logical formula (7) to the first associative memory processing unit 18. The description below will be given on an example in which the mutual recall type associative memory is selected as an associative memory operation of the first associative memory processing unit 18.

In step F, the first associative memory processing unit 18 executes numeric vectorization on each term included in the logical formula (7) according to the method of word2vec, and applies the mutual recall type associative memory to each term to obtain the following three logical formulas. The first associative memory processing unit 18 then outputs these logical formulas to the word relevance analysis unit 17.

“dislike(Steve,CompanyX).” (9)

“hate(Tom,CompanyX).” (10)

“hate(Steve,CompanyY).” (11)

In step G, the word relevance analysis unit 17 inputs the logical formulas (9) to (11) themselves as search keys to the inference engine in the knowledge accumulation unit 15 in order to check whether the logical formulas (9) to (11) are included in the knowledge database within the knowledge accumulation unit 15. Then, in step H, the word relevance analysis unit 17 obtains the determination of Yes (0) for the logical formula (9) and No (x) for the others.

In step I, the word relevance analysis unit 17 considers that the logical consistency of the logical formula (7), i.e., the logical formula (9) regarded as the association result, has been guaranteed, and outputs the logical formula (7) to the logical formula construction unit 19 via the hypothesis generation unit 16.

In step J, in order to convert the logical formula (7) into one in the natural language, the logical formula construction unit 19 outputs the logical formula (7) to the second time-series signal conversion unit 20, thereby acquiring

“Steve hates CompanyX. (12)

The conversion from the logical formula (7) to the sentence (12) can be implemented by the second time-series signal conversion circuit acquired through the learning with the echo state network as described in Reference 2. Furthermore, the sentence (12) is output to the sentence output unit 21 and then output externally via a display or sound interface.

In the present embodiment, an example has been described in which the mutual recall type associative memory is selected by the word relevance analysis unit 17 as the associative memory operation of the first associative memory processing unit 18, but the self-recall type associative memory may be selected by the word relevance analysis unit 17. Furthermore, while an example of application to a dialogue system based on the natural language has been described, the present embodiment can also be used for other applications, such as machine translation or even for applications dedicated for web search.

In the present embodiment, an example has been described in which a certain amount of knowledge is accumulated in the knowledge accumulation unit 15, but another method of storing the knowledge may be used. For example, a logical formula newly generated in each operating unit in the present embodiment may be accumulated in the knowledge accumulation unit 15 as a new knowledge. Furthermore, the knowledge accumulation unit 15 may be constructed by a database without an Internet connection, by a centralized database connected to the Internet, or by a distributed database, such as a cloud system.

In the present embodiment, the usage of the word2vec has been explained by way of example as the means for vectoring words in the word relevance analysis unit 17, but other vectorization methods suitable for use include, for example, a method of executing numeric vectorization by using the ASCII code or the like as each letter composing a word (e.g., apple is expressed as (0x61, 0x70, 0x70, 0x6c, 0x65), where 0x is a hexadecimal representation), a similar vectorization method thereto, and a method which involves assigning back numbers to 256 fixed words and converting each back number into an 8-bit binary digit to execute numeric vectorization (e.g., converting the back number 129 to a binary digit (1,0,0,0,0,0,0,1)).

Thus, in the dialogue system based on the natural language, the associative memory device according to the present embodiment converts a sentence with an ambiguous meaning input by the user into a predicate logical formula by using the time-series signal conversion function acquired through the learning with the echo state network. The associative memory device then outputs a word associated with each word constituting this predicate logical formula by using the associative memory function acquired through the learning with the echo-state network. The associative memory device then generates a new predicate logical formula from the associative result derived by the inference engine after the predicate logical formula is input to the predicate logical formula of the knowledge accumulation unit. The associative memory device creates a natural language-based response sentence from the new predicate logical formula by using the time-series signal conversion function acquired through the learning with the echo state network and then outputs the created response sentence. Thus, the associative memory device according to the present embodiment does not need to prepare separate logics for the time-series signal conversion and the associative memory, unlike the prior art, and can implement both time-series signal conversion and associative memory with the single echo state network. As a result, the appropriate response to the sentence with the ambiguous meaning input by the user can be output as the sentence in the natural language.

As described above, when the associative memory circuit and the time-series signal conversion circuit are constructed, the associative memory circuit and the time-series signal conversion circuit can be acquired through the learning with the echo state network, which is a recurrent neural circuit model, thus avoiding the problem of the combinatorial explosion of computational complexity in converging the learning and also to implement the information processing system capable of operating at high speed. In addition, when the natural language processing system is constructed, the associative memory learning and the time-series signal learning can be implemented by using one echo state network alone, which is a recurrent neural circuit model, thus avoiding an increase in hardware resources and implementing a compact information processing system.

### Third Embodiment

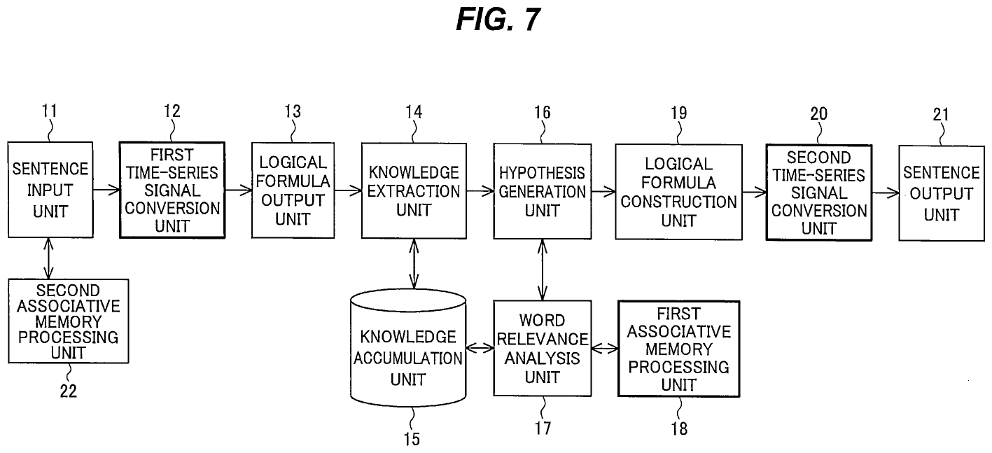

FIG. 7 is a block diagram showing a configuration of respective operating units of an associative memory device according to a third embodiment. The associative memory device performs the information processing which includes the time-series signal learning for processing time-series information and the associative memory learning for processing pattern information. The associative memory device corrects spelling of an input sentence by using the self-recall type associative memory of the echo state network. This embodiment differs from the second embodiment in that the sentence input unit includes a second associative memory processing unit, in addition to the first associative memory processing unit included in the word relevance analysis unit, for the purpose of automatically correcting a word included in an input sentence if the word contains an error.

A second associative memory processing unit 22 holds herein a second associative memory circuit acquired through the associative memory learning with the echo state network. The second associative memory circuit is acquired through the learning with the echo state network in the same way as in the first embodiment where the associative memory circuit is acquired through the learning with the echo state network in the associative memory learning unit 3. The second associative memory processing unit 22 uses the second associative memory circuit to automatically correct a word included in an input sentence when the word contains an error. The second associative memory processing unit 22 outputs the automatically corrected word to the sentence input unit 11.

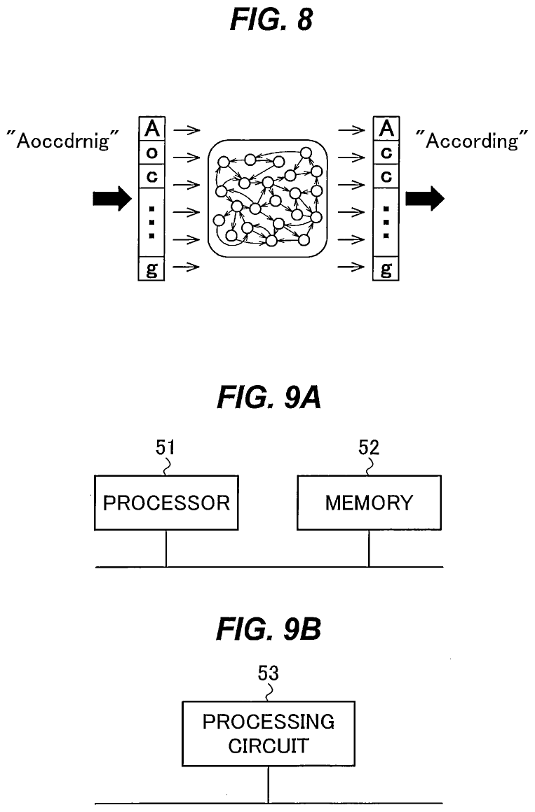

FIG. 8 shows the learning operation of the associative memory learning unit and the utilization mode of the associative memory processing unit. In this embodiment, the second associative memory circuit held in the second associative memory processing unit 22, which uses the echo state network, automatically corrects a word containing an error in a sentence in the natural language. This operation will be described with reference to FIG. 8.

First, the following example sentence will be considered as a sentence that is input into the sentence input unit 11.

(Sentence 1) Aoccdrnig to a rscheearch at Cmabrigde Uinervtisy, it deosn't mttaer in waht oredr the ltteers in a wrod are, the olny iprmoetnt tihng is taht the frist and lsat ltteer be at the rghit pclae. the rset can be a toatl mses and you can sitll raed it wouthit porbelm. tihs is bcuseae the huamn mnid deos not raed ervey lteter by istlef, but the wrod as a wlohe.

A sentence 1 is an example sentence described in https://en.wikipedia.org/wiki/Typoglycemia to explain human cognitive characteristics, called typoglycemia. This sentence is composed of words in which each word with a string length of 4 or more among the words included in the sentence except for the first and last letters is misspelled. According to the human cognitive characteristics, the sentence 1 can be corrected to a sentence 2 below.

(Sentence 2) According to a researcher at Cambridge University, it doesn't matter in what order the letters in a word are, the only important thing is that the first and last letter be at the right place. The rest can be a total mess and you can still read it without problem. This is because the human mind does not read every letter by itself, but the word as a whole.

As is clear from comparing the sentence 1 with the sentence 2, each of some words composing the sentence 1 can be seen to contain a partial defect in a corresponding word composing the sentence 2. Therefore, by applying the self-recall type associative memory according to the invention, each of some words composing the sentence 1 can be automatically corrected to the corresponding word in the sentence 2. For example, the first word in the sentence 1, “Aoccdrnig,” and the first word in the sentence 2, “According,” can have each letter numerically represented by a two-digit hexadecimal character code such that both words are used in string processing on general-purpose computers. Thus, both “Aoccdrnig” and “According” can be regarded as numeric vectors. Therefore, error parts contained in the word can be automatically corrected through the self-recall type associative memory learning of each word with the echo state network. As a result, “Aoccdrnig” can be converted to “According” as shown in FIG. 8.

In this embodiment, an example has been described in which the vectorization of each word of the sentence 1 is performed by using a two-digit hexadecimal character code, but another vectorization method suitable for use is, for example, a method which involves assigning back numbers to 32 fixed words and converting each back number into a 5-bit binary digit to execute numeric vectorization (e.g., converting the back number 17 to binary digits (1,0,0,0,1)).

Thus, in the dialogue system based on the natural language, the associative memory device according to the present embodiment has the following functions of: automatically correcting an error part in a user-entered sentence containing an error(s) in words or context by using the associative memory function acquired through the learning with the echo state network; converting the sentence automatically corrected into a predicate logical formula by using the time-series signal conversion function acquired through the learning with the echo state network; outputting a word associated with each word constituting this predicate logical formula by using the associative memory function acquired through the learning with the echo-state network; generating a new predicate logical formula from the associative result derived by the inference engine after the predicate logical formula is input to the inference engine in the knowledge accumulation unit; and converting the predicate logical formula into a sentence in the natural language by using the time-series signal conversion function acquired through the learning with the echo state network. Thus, the associative memory device according to the present embodiment does not need to prepare separate logics for the time-series signal conversion and the associative memory, unlike the prior art, and can implement both time-series signal conversion and associative memory with the single echo state network. As a result, an appropriate response to the sentence input by the user can be output as the sentence in the natural language.

As described above, when the associative memory circuit is constructed, the associative memory circuit can be acquired through the learning with the echo state network, which is the recurrent neural circuit model, thus avoiding the problem of the combinatorial explosion of computational complexity in converging the learning and also to implement the information processing system capable of operating at high speed. In addition, when the natural language processing system is constructed, the associative memory learning and the time-series signal learning can be implemented by using one echo state network alone, which is a recurrent neural circuit model, thus avoiding an increase in hardware resources and implementing a compact information processing system.

The hardware configuration of the associative memory device will be described here. Each function of the associative memory device can be implemented by a processing circuit. The processing circuit includes at least one processor and at least one memory.

FIGS. 9A and 9B show the hardware configuration of the associative memory devices according to the first to third embodiments. The associative memory device can be implemented by a control circuit shown in FIG. 9A, i.e., a processor 51 and a memory 52. Examples of the processor 51 include a CPU (also called a Central Processing Unit, central processing unit, processing unit, arithmetic unit, microprocessor, microcomputer, processor, or Digital Signal Processor (DSP)) and a system Large Scale Integration (LSI). The memory 52 is, for example, a nonvolatile or volatile semiconductor memory such as a Random Access Memory (RAM), a Read Only Memory (ROM), a flash memory, an Erasable Programmable Read Only Memory (EPROM), or an Electrically Erasable Programmable Read-Only Memory (EEPROM) (registered trademark), a magnetic disk, a flexible disk, an optical disk, a compact disk, a mini disk, or a Digital Versatile Disc (DVD).

The associative memory device is implemented by causing the processor 51 to read out and execute a program stored in the memory 52 for performing the operation of the associative memory device. This program can also be said to cause the computer to execute the procedure or method of the associative memory device. The programs to be executed by the associative memory device are loaded onto a main memory device, and these are generated in the main memory device. The memory 52 stores memory patterns, recall patterns, and the like. The memory 52 is also used as a temporary memory when the processor 51 executes various processes.

The program to be executed by the processor 51 may be provided as a computer program product that is stored on a computer-readable storage medium in an installable or executable format file. The program to be executed by the processor 51 may also be provided in the associative memory device via a network such as the Internet.

The associative memory device may be implemented by dedicated hardware. Some of the functions of the associative memory device may be implemented by dedicated hardware, and others may be implemented by software or firmware.

The associative memory device may be implemented by a dedicated processing circuit 53 shown in FIG. 9B. At least part of a grasp point generating unit 31 and a command value generating unit 39 may also be implemented by the processing circuit 53. The processing circuit 53 is dedicated hardware. The processing circuit 53 is, for example, a single circuit, a complex circuit, a programmed processor, a parallel programmed processor, an Application Specific Integrated Circuit (ASIC), a Field Programmable Gate Array (FPGA), or a combination of these. Some of the functions of the associative memory device may be implemented by software or firmware, and the remainder may be implemented by dedicated hardware.

### DESCRIPTION OF REFERENCE CHARACTERS

1 Memory pattern specifying unit
2 Recall pattern specifying unit
3 Associative memory learning unit
4 Associative memory processing unit
5 Pattern input unit
6 Pattern output unit
11 Sentence input unit
12 First time-series signal conversion unit
13 Logical formula output unit
14 Knowledge extraction unit
15 Knowledge accumulation unit
16 Hypothesis generation unit
17 Word relevance analysis unit
18 First associative memory processing unit
19 Logical formula construction unit
20 Second time-series signal conversion unit
21 Sentence output unit
22 Second associative memory processing unit

1. An associative memory device comprising:
processing circuitry
to store a fixed-length numeric vector as a memory pattern;
to store a numeric vector associated with the memory pattern as a recall pattern;
to acquire an associative memory circuit through learning by using an echo state network including an input layer, an intermediate layer, and an output layer, values of all units constituting the input layer being input in parallel to the intermediate layer, values output in parallel from the intermediate layer through neural network processing performed within the intermediate layer being set as values of all units constituting the output layer, the recall pattern being output in parallel from the associative memory circuit by inputting the memory pattern in parallel to the associative memory circuit; and
to hold therein the associative memory circuit acquired through the learning.

2. A associative memory device comprising:
processing circuitry
to store an input sentence expressed in a natural language;
to hold a first time-series signal conversion circuit acquired through learning with an echo state network and to convert the input sentence into a predicate logical formula by using the first time-series signal conversion circuit;
to store the predicate logical formula;
to accumulate knowledges in an inference engine where all knowledges are stored as a knowledge database in form of predicate logic and inference is performed in accordance with a rule of the predicate logic and to search knowledges accumulated in the inference engine by using the predicate logical formula;
to conduct a search across the inference engine by using the predicate logical formula as a search logical formula, and to acquire, as a candidate conditional logical formula, the predicate logical formula which is a search result;
to verify the search logical formula against the candidate conditional logical formula by using hypothetical reasoning, and to generate a plurality of hypothetical logical formulas based on the hypothetical reasoning;
to check on a symbolic basis whether each word constituting the plurality of hypothetical logical formulas is included in the knowledge database s unit, to select an operation of either a self-recall type associative memory or a mutual recall type associative memory, and to extract the hypothetical logical formula that is determined to be included in the knowledge database on the symbolic basis from among the plurality of hypothetical logical formulas;
to hold a first associative memory circuit acquired through the learning with the echo state network, to execute the first associative memory circuit for the extracted hypothetical logical formula based on operation selection information about the selected operation of either the self-recall type associative memory or the mutual recall type associative memory, and to obtain an associative hypothesis logical formula resulting from the execution;
to store an output logical formula selected from the associative hypothesis logical formulas;
to hold a second time-series signal conversion circuit acquired through the learning with the echo state network and to convert the output logical formula into an output sentence expressed in a natural language by using the second time-series signal conversion circuit; and
to output the output sentence externally.

3. The associative memory device according to claim 2, wherein:
the processing circuitry holds a second associative memory circuit acquired through learning with the echo state network and to automatically correct a word containing an error included in the input sentence by using the second associative memory circuit.
